(19) United States
(12) Patent Application Publication
(10) Pub. No.: US 2024/0396361 A1
(43) Pub. Date: Nov. 28, 2024

(54) DC Power Plant and Method of Recharging the Same

(71) Applicant: C&C Power, Inc., Carol Stream, IL (US)

(72) Inventor: James Leo LEIFKER, Carol Stream, IL (US)

(73) Assignee: C&C Power, Inc., Carol Stream, IL (US)

(21) Appl. No.: 18/641,066

(22) Filed: Apr. 19, 2024

Related U.S. Application Data
(60) Provisional application No. 63/503,531, filed on May 22, 2023.

(51) Int. Cl. H02J 7/04; H02J 7/00; H02J 9/06

(52) U.S. Cl. CPC H02J 7/04; H02J 7/00308; H02J 7/0068; H02J 7/00716; H02J 7/007186; H02J 9/061; H02J 2207/20

(57) ABSTRACT

A DC Power Plant converts an alternating current power input to a DC voltage to supplied to a load may have an associated storage-battery module to provide continued power to the load when there is an interruption of the alternating current power input. When power is restored to the DC Power Plant, the battery module needs to be recharged to replace the energy depleted during the power interruption. The value of the recharging current is controlled such that the recommended recharging rate is not exceeded by comparing the measured recharging current with a predetermined set-point value and determine an error value which is modified by a first and a second shaping function to control the DC voltage output, where the selection between the first and the second shaping function is approximately at the state of recharging when the battery transitions to a charging state.

This application claims the benefit of priority to U.S. provisional application Ser. No. 63/503,531, entitled “DC Power Plant and Method of Recharging the Same” filed on May 22, 2023, which is incorporated herein in its entirety by reference.

### TECHNICAL FIELD

This application may have relevance to the controlling the rate of recharging of storage batteries.

### BACKGROUND

Direct current (DC) power is needed for many types of telephone communication equipment, for control equipment used at electric utility substations, computer data centers, and power plants, and other similar uses. The DC power source may be supplied with AC power from an AC power source, such as the local power grid, or a generator and prime mover. Interruptions in the continuity or quality of the power supply to the using equipment may compromise safety or cause economic loss and DC power sources may be configured with storage batteries as a temporary source of power until the prime power is restored. When the power is restored, the storage batteries need to be recharged to replace the energy that was expended.

An example of such a power supply system may be termed a DC Power Rack, a DC Power Plant, Uninterruptable Power Supply (UPS) or the like and may comprise one or more AC-to-DC conversion modules (“rectifiers”), a controller to manage the operation of the system and one or more storage batteries which may be sealed lead-acid batteries (SLA) or other battery chemistries.

In an example, lead-acid storage batteries can be charged using various methods, including constant voltage, constant current, taper current, and two-step constant current. For sealed lead-acid batteries, the charging voltage typically ranges from 1.75 to 2.40 volts per cell where 2.25 volts per cell is the float state of the cell and where voltages above 2.25 volts per cell may be used to equalize charge of a group of cells may be applied to the battery terminals.

For constant current charging, the charge time and quantity can easily be calculated if the discharged ampere-hours of the preceding discharge cycle are known. However, it is highly desirable to obtain a highly accurate constant charging current, and monitoring of charge voltage is necessary to avoid overcharging the battery. The recommended constant float voltage is 2.25 to 2.30 volts per cell, which allows the fully-charged battery to define its own current level and remain fully charged without having to disconnect the charger.

Lead acid batteries are comprised of strings of 2 volt (nominal) cells connected in series, commonly 2, 3, 4, or 6 cells per battery. Strings of lead acid batteries may be charged in series safely. When charging a high-voltage string of batteries with a single constant-voltage charger, the same current flows through all cells in the string, which may cause some batteries to overcharge while others remain slightly undercharged. When connecting batteries in parallel, the current from a charger will divide almost equally between the batteries, However, if batteries of unequal capacity are connected in parallel, the current will tend to divide between the batteries in the ratio of capacities (internal resistances).

The maximum recommended charge rate for lead acid batteries is usually specified by the manufacturer and can vary depending on the battery type, capacity, and chemistry. Generally, a charge current of 10 percent to 30 percent of the battery ampere hour (Ah) rating of a lead-acid battery is recommended. For other battery chemistries the recommended charging current may vary.

Charging lead-acid batteries at rates higher than the recommended maximum can cause excessive heat, gas evolution, and can lead to reduced battery life or even damage the battery.

### SUMMARY

A DC Power Plant is disclosed, comprising an AC-DC power converter connectable to an external source of electrical power and having a controllable DC output voltage, connectable to a storage battery and an electrical load, an ammeter connected between a DC output terminal of the AC-DC power converter output terminal and a connected battery module.

A digital controller, processor or computer is configured to sample a value of the current flowing through the ammeter and to control the AC-DC power converter DC output terminal voltage such that an error signal, being a difference between a set-point current and a sampled current value is processed by a proportional integral (PI) control module. The error signal output control value of the PI controller is modified by a by a predetermined transfer function to control the DC output terminal voltage such that a charging current supplied to the battery module at or below the set-point current. Two or more transfer functions may be used to speed the charging process without overshooting the recommended charging current and the transition between a first charging function and a second charging function may occur at approximately the stage of charging when the current supplied to the battery changes from a discharging state to a charging state.

In an aspect, the DC Power Plant may include the battery module.

In another aspect, a method of managing the recharging of a battery, a string of batteries or a plurality of strings of batteries connected in parallel and connected to a load is disclosed, wherein a rectifier having a controllable voltage output, an ammeter connected in series between the battery and the rectifier and a controller with a memory for storing computer instructions, performs the steps of measuring a value of a current input to a battery, comparing the measured current value to a predetermined set-point-current value to determine an error value; using a proportional integral (PI) controller to produce a control voltage proportional to the error value and modifying the control voltage according to a first control law or a second control law, depending on on the value of the measured current being greater than or less than a predetermined transition value; and using the modified control voltage to change the controllable output voltage where the process continues until the controllable voltage value is equal to a float voltage value.

The predetermined transition value is related approximately to the stage of the recharging process where the battery state has changed from a discharging state to a charging state (that is, changes sign), including any effect of the DC Power Plant supplying power to a connected load.

### BRIEF DESCRIPTION OF THE DRAWINGS

FIG. 1 is a simplified diagram of a DC Power Plant connected to an external electrical load and to a battery;

FIG. 2 is an example of the behavior of the current and voltage before, during and after an input power failure, where a battery has been partially discharged and is recharged when the charging voltage is controlled by a proportional integral (PI) controller;

FIG. 3 is a functional block diagram of the control process for recharging the battery using a PI controller and showing a modification of the charging control function to start charging the batteries quickly and maintain the set-point charging current in a controlled manner; and

FIG. 4 shows the behavior of the current and voltage before, during and after an input power failure, where a battery has been partially discharged and is re-charged, when the charging voltage is controlled by a proportional integral controller (PI) whose control voltage output has been modified.

### DETAILED DESCRIPTION

Exemplary embodiments may be better understood with reference to the drawings, but these examples are not intended to be of a limiting nature. Like numbered elements in the same or different drawings perform equivalent functions. When a specific feature, structure, or characteristic is described in connection with an example, it will be understood that one skilled in the art may use such feature, structure, or characteristic in connection with other examples, whether or not explicitly stated herein.

Embodiments of this invention may be implemented in hardware, firmware, software, or any combination thereof. In an aspect, where a computer or a digital circuit is used, signals may be converted from analog format to a digital representation thereof in an analog-to-digital (A/D) converter, as is known in the art. The choice of location of the A/D conversion function will depend on the specific system design. The terms digital controller, processor and computer are well known to persons of skill in the art and are often used interchangeably, and may include, for example, programmable-gate arrays and the like.

The instructions for implementing processes measurement, data analysis and communications processes may be provided on computer-readable storage media. Computer-readable storage media include various types of volatile and nonvolatile storage media. Such storage media may be memories such as a cache, buffer, RAM, flash, removable media, hard drive, or other computer readable storage media. The functions, acts or tasks illustrated in the figures or described herein may be performed in response to one or more sets of instructions stored in or on computer readable storage media. The functions, acts or tasks are independent of the particular type of instruction set, storage media, processor or processing strategy and may be performed by software, hardware, integrated circuits, firmware, micro code or the like, operating alone or in combination. The instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system. At least one memory component of the system shall be capable of storing the instructions in a non-volatile memory.

A DC battery system (DC Power Plant) may consist of a lead-acid storage battery, two or more lead-acid storage batteries in a series string, or one or more such battery strings in parallel, connected to an external electrical load, and a charging device (recharging device may generally used interchangeably with charging device) to replenish the charge of the batteries when the batteries have been used as a temporary source of power, or to maintain the state-of-charge (SoC) of the batteries in anticipation of a power loss.

The DC-Power Plant may also serve as the energy storage component of an Uninterruptable Power Supply (UPS) where the energy from the batteries supplies an inverter and a static switch to maintain continuity of power for equipment using AC power.

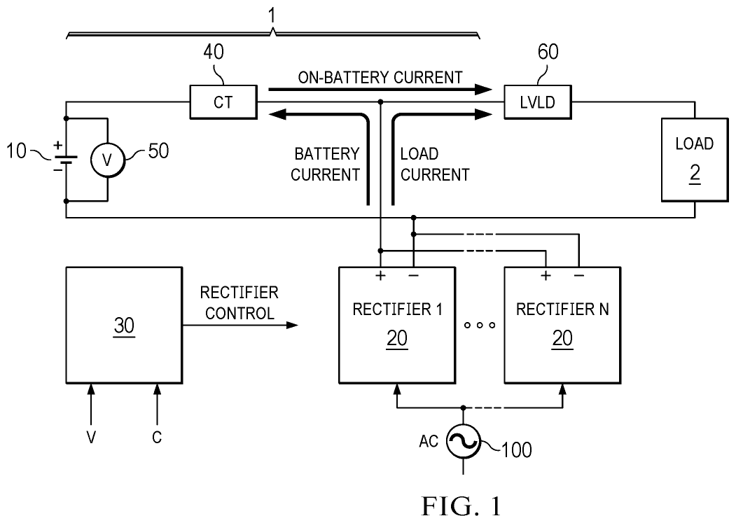

An example of a DC Power Plant is shown in FIG. 1, where the voltage V applied to the load 30 depends on the requirements of the specific equipment being powered, and typically ranges from 48 VDC to 480 VDC although both higher and lower voltages are used. In a telecommunications application, for example, 48 VDC may be used. A plurality of rechargeable storage batteries 10 is connected in series to result in the design current and ampere-hour capacity and voltage to supply to the load 30. In this example, storage batteries, such as lead-acid technology batteries, may have an open-circuit terminal voltage of 12.9 VDC and a plurality of batteries may be connected in series to obtain the design voltage. (In the present description, a terminal voltage of 12 VDC, or 2 VDC per cell, may be used as an approximation, for convenience.) The capacity of the storage batteries is expressed in ampere-hours and is a measure of the time-to-discharge of a battery supplying a known current, but storage batteries are not normally fully discharged in operation. The current requirements of the load may exceed that which may be supplied by a single string of storage batteries, and thus a plurality of storage-battery strings comprised of a plurality of storage batteries connected in series would be connected in parallel.

Batteries in the battery strings are ordinarily combined such they have substantially the same age, capacity, internal resistance, operating temperature, and other characteristics, such as terminal voltage and float current. A comparison of the performance of the individual battery strings with respect to each other or quantitatively individually may provide an indication of the quality state or “health” of the batteries, and permit servicing of the battery system prior to an actual failure. Limit values may also be set to initiate alarms. Methods of monitoring battery string condition, may be incorporated in the DC Power Plant or added as supplementary devices to detect, for example, battery thermal run-away or other incipient failure modes. They are not further described herein.

FIG. 1 shows a simplified block diagram of a DC Plant 1 consisting of rectifiers 20, batteries 10, a current transformer (ammeter) 40, voltmeter 50, a connected controller 30 other ancillary devices and and an external load. When AC power 100 is present, rectifiers 20 supply DC power to the load 2 while maintaining the state-of-charge (SoC) of the batteries. In this state, the rectifiers may supply the current needed by the load 2 while the batteries 10 are in a float condition. When in the float condition, the batteries require a small amount of current as compared with the load. When there is a loss of AC power, the rectifiers supply no power and the entire load current demand of the load is satisfied by the batteries. The battery terminal voltage drops as bateries proivide energy to the load, and the battery terminal voltage declines as the stored power is used.

Providing that the power outage is of less duration than the ampere-hour capacity of the batteries, the load will continue to perfom its function. When the AC power is restored within this time period, the rectifiers again begin supplying current to the load, but are also required to suppply current to the batteries to replenish the energy supplied during the outage.

The DC Power Plant 1 may have an optional Load Voltage Load Disconnect (LVLD) device 60 that automatically disconnects the load 2 from the DC Plant 1 from the battery by means of a heavy-duty contactor should the battery terminal voltage drops below a preset level. Discharging lead acid batteries below 1.75 V per cell may degrade or damage the batteries so one would disconnect the load below that voltage using the LVLD such as is obtainable from LeMarch MFG, DesPlaines, IL. This action protects the load from being connected to below, for example 42 VDC for a 48 volt battery string.

The load may be reconnected automatically by the LVLD when the battery voltage V returns to the desired voltage. Where the LVLD has dicsconnected the load, restoration of source power to the DC Plant may not immediately restore DC power to the load. Rather, the DC Plant begins the battery re-charging by supplying current only to the battery until the battery voltage again exceeds the actuating threshold of the LVCD.

Where the term battery is used in this description, one should understand that one or more batteries, in series strings or such strings in parallel may be configured to supply current to the load as specified by the user and for a specified time duration. Moreover such batteries may be internal to a cabinet housing the other compponents of the DC Power Plant, or be external thereto.

The maximum permitted current for recharging is specified by the battery manufacturer (typically between 0.1 and 0.3 C, where C is the ampere-hour capacity) so as to prevent damage to the battery due to overheating or other chemical processes and to achieve the warranteed lifetime. However, the current provided to the battery under these conditions depends on the battery terminal voltage and the state-of-charge (SoC) of the battery and may substantially exceed the recommended charging current value if the output voltage of the rectifier of the DC Plant remained at the pre-outage value.

Without appropriately controlling the charging current, this approach rapidly returns the system to a state where the battery is charged, but the behaviour is detrimental to the battery life and may cause hazardous situations and needs to be avoided. The inventor has observed that while there is no detrimental effect of a rapid rise in current initially, the situation becomes unsatisfactory when the the battery transitions from a discharging state to a charging state, while connected to the load.

Deternining, a priori, the voltage at which to begin operating after a power outage is fraught and a starting voltage considerably less than that of a float condition would need to be conservatively chosen and the voltage raised slowly during the charging process until the batteries are fully recharged. The controller could measure the the actual battery current and adjust the rectifier voltage to maintain the desired battery charge current at less than or equal to the manufacturers recommended value.

In view of the dependence of the recharging current on the SoC at the time of power loss and the load demands, such a control system has dynamical properties and can lead to situations where the instantaneous current substantilly exceeds the recommended charging current limit, and this may include oscillitory behaviour. The design objective with a controllable-voltage charging cycle is to raise the rectifier voltage from a low starting level (perhaps the battery terminal voltage during discharge) to the eventually-achieved float-voltage level expeditiously, without detrimental overshoot or oscillitory behavior.

Since the battery terminal voltage changes during the re-charging process and the charging current is proportional to the rectifier output voltage and inversel proportional to the SoC, the control of the rectifier output voltage is a moving target, which may be further complicated by any time-varying current demands of the load. In the present example system, the quantity of current to be supplied is limited to a maximum value less than or equal to the manufacturer's recommended value and this is accomplished by varying the rectifier output voltage.

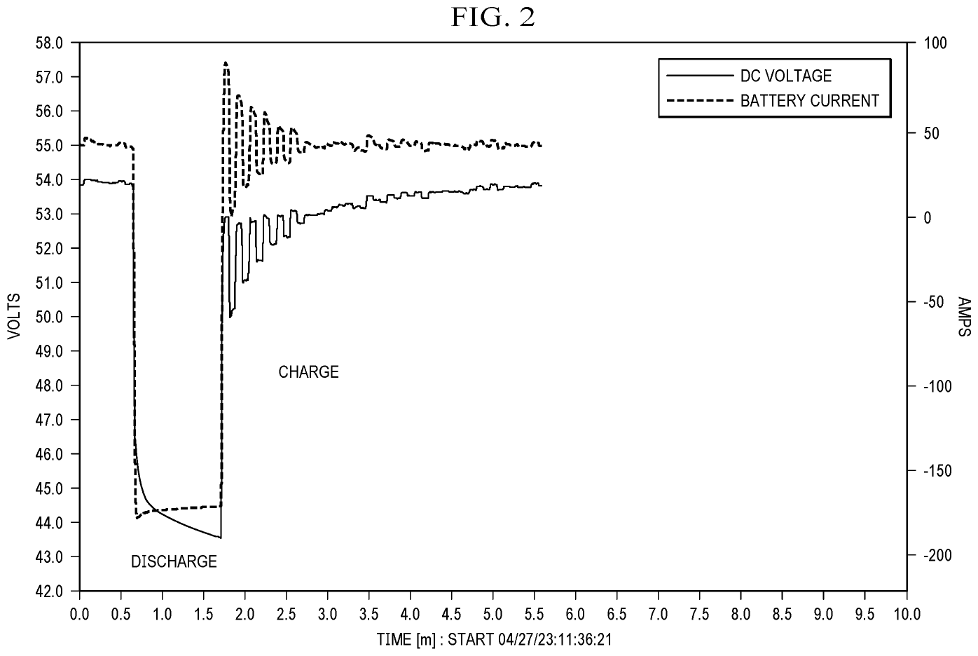

FIG. 2 is a simulation of the performance of a DC Power Plant 1 where the initial condition at 0 minutes (m) is that the battery is being charged at 40 amps which, in this example, is the manufacturer's recommended maximum charging rate. The power is lost at about 0.7 m and the battery immmediately begins to supply power to the load 2 at a level of −170 amps, where the negative sign indicates that power is flowing out of the battery. After initially dropping sharply to 44.2 volts, the voltage continues to decline slowly until power is restored. If the voltage output of the rectifiers 20 had remained the same as that prior to the loss of power, the initial current supplied to the battery would likely substantially exceed the maximum permitted current. The simulation to mitigate this situation by measuring the battery current and determining an error value that is the difference between the desired charging current and the current measured by the ammeter 40. For this example, the initial output voltage of the rectifier 30 may start at the measured battery voltage under load (about 43.5) and adjusted by a value proportional to the error value using a proportional integral (PI) controller. The effect is a substantial increase in current, transitioning from a discharging state to a charging state where the current now exceeds the maximum charging current and the sign of the error value reverses sign. The rectifier voltage is reduced, but by too large a value and oscillatory behaviour of both the recitifier voltage and the charging current is observed.

While this approach reapidly returns the system to a state where the battery is being charged, this approach is detrimental to the battery life and is to be avoided. The inventor has observed that while there is no detrimental effect of a rapid rise in current initially, the situation is unsatisfactory when the voltage rise causes the battery to transition from a discharging state to charging state and continue continues to maintain the same PI control parameters so that the charging current exceeds the set-point value. The rate of rectifier output voltage rise needs to be shaped so as to avoid the problem.

Mittigating the overshoot effect with a simple proportional integral (PI) controller by reducing the gain settings would result in a very slow adaptation and not actually reaching the preset charging current limit. A PI controller overcomes some of these limitations by adding a control signal proportional to the integral of the difference between the measured current and the set point current The proportional integral (PI) controller, is typically realized as a digital processer module or function using a sampled data approach, however discrete circuitry can be used.

Even this configuration has a limitation on the rate of increase of supply voltage and has a tendency to overshoot the set-point current for reasonable parameter settings. While the early-time behaviour of the control function is improved, the PI controller does not result in a conservative approach to rapidly converging on a voltage to achieve the desired set-point current.

Experimentally, the inventor has found that the control voltage output of the PI controller needs further shaping to be able to use reasonable PI controller parameter values while raidly reaching the set-point charging current without overshoot. Two analytic shaping functions may be particularly effective and conveniently applied as an output shaping of the PI control loop: a square-root function at early times and a cube root function at later times when the battery transitions from a discharging state to a charging state. While such analytic shaping functions are conveniently implemented in a digital processor, it is also possible to represent the same or similar shaping functions in tabular form as a look-up table stored in the processor memory.

When the rectifier output voltate reaches the float-state value and is maintained, the battery becomes fully charged and the current decreases to the float current value at the float voltage. Using the known battery float voltage as the upper limit on the rectifier voltage avoids overcharging the battery while maintaining a full SoC. The re-charged DC Power Plant now supplies all of the current demand of the load while maintaining the fully-charged state of the batteries.

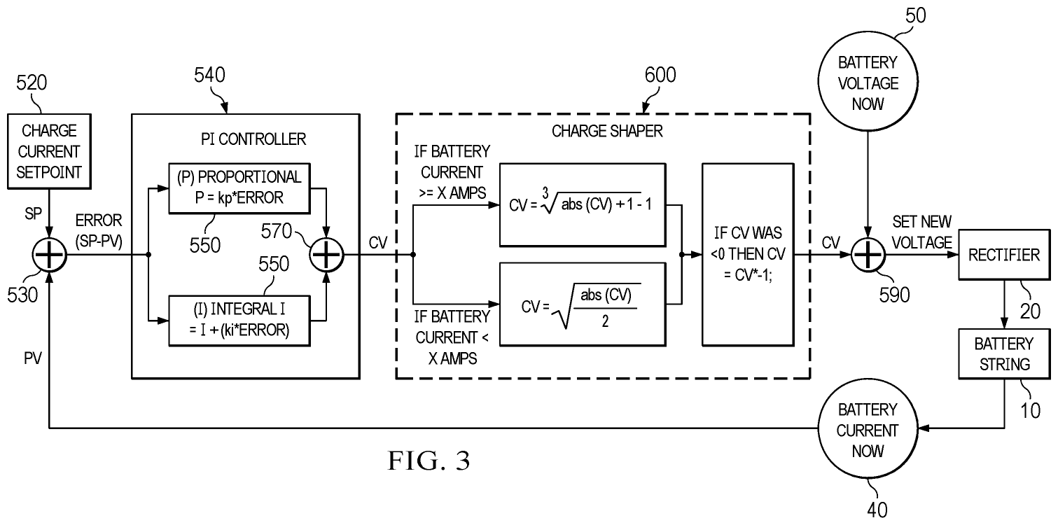

An example of a DC Plant charging control circuit 500 is shown in FIG. 3 as a simplified block diagram where a function of each block may typically be performed by either hardware elements or by computer readable instructions. Some identified aspects such as the battery string, the rectifiers and the sensing elements of a voltmeter or ammeter will be recognized by persons of ordinary skill in the art to be entirely or predominantly electrical hardware while other aspects may be more conveniently performed by a digital controller or processor programmed to perform the needed operations.

Definition of terms:

| | |
|---|---|
| PI Controller (PI) | Proportional, Integral controller. |
| Process Variable (PV) | Battery current now. |
| Set Point (SP); | Battery maximum charge-current setting. |
| Error (SP − PV); | Difference between the battery charge-current |
| | setting and the battery current now. |
| Control Var (CV); | Unitless value added to the output voltage |
| | causing a change in battery current. CV = (P + I). |

The operation of the control function may be considered as beginning with the measurement of the current flowing into (+) or out of (−) the battery 10 by the ammeter 40 (see FIG. 1) in function block 510 of FIG. 3 and the comparison of the measurement (PV: process variable) with a predetermined charge current set-point variable 520 in a comparator 530 to develop an error signal (SP-PV). The error signal is applied to the input of a P or a PI controller 540, where the error signal is multiplied 550 by predetermined gain constants to produce a control variable (CV) in 570. For the nonce, we proceed in the description without further details of the Charge Shaper 600, which is described in the sequel.

The control varaible CV is used to adjust the voltage output of the rectifier 590 by summing the control variable CV with the rectifier voltage Vr, 620 as measured by the voltmeter 60. The adjusted rectifier voltage Vr output to the battery string 10 may cause a change in the current supplied to the battery 10 and the resultant current is again measured by the ammeter 40 and the charging continues in a closed-loop manner until a preset limit point (usually battery voltage equal to float voltage), when the voltage is maintained at Vfloat and the charging continues. Eventually, as the battery 10 reaches full charge, the measured charging current drops to a very low value. The rectifier voltage is maintailed at Vfloat so as to trickle charge the battery 10 while continuing to supply current to the load 2. Since the output of the PI controller is not relevant after reaching the float state, the process 500 may be discontinued until it is reinitiated by a discharging event.

As prevously discussed, the configuration described, without the charging shaper, results in a charging current profile of the type shown in FIG. 2, which is unsatisfactory. The charging profile needs to avoid overshoot while rapidly converging on the set-point current in order to charge the battery 10 in the shortest practical time. As previously discussed, the P controller permits the rapid initial rise in charging current. But such behaviour cannot be permtted to continue. The inventor has experimentally observed that the character of the charging changes when the rectifier voltage Vr is such that the current measured by the ammeter 40 changes sign from discharging (−) to charging (+), corresponding to the voltage where the rectifier can provide sufficient current to supply the load requirements as well as begining to charge the battery. The transition voltage depends, amongst other factors, to the power demand of the load, the SoC of the battery and the set-point current.

The maximum charging current for each of the strings in a multiple string installation based on the manufacturer's recommendations and the number of parallel battery strings in a particular installation determines the total set-point current 520. While the voltage at which this transition occurs may be difficult to predict, the change of sign for the battery current is distinctive. This trainsition from discharging state to charging state be determined confidently, as once the transition occurrs there is no reason except a power failure to return to a discharging state. Hence, we can set a regime of current values which may constitute this transition region and once the transition occurrs, the charging proceeds to completion.

Since the load remains connected to the battery througout the charging-discharging cycle and the system voltage at the end of the power outrage is determined by the battery terminal voltage, the initial phase of the recharging portion begins with the battery continuing to supply power to the load at that voltage. As the rectifier voltage output is increased from this level, the rectifier begins supplying power to the load, thus reducing the demand for current from the battery, until the rectifier voltage has risen to the point where the rectifier can supply the load power requirements as well as supply power to the battery. As the rectifier voltage continues to be increased, the battery is being charged at an increasing current value until the set-point-current limit is reached. The battery is still not in a fully charged state and is charged at the set-point current and float voltage until the battery is nearly fully charged. The current flowing into the battery slowly decreases, at the relatively stable voltage, until the float state is reached where the battery terminal voltage is the float voltage, which is an appropriate rectifier fixed voltage.

The ability of a PI controller to manage the entire recharging process depends on a particular balance between the proportionality constants kp and ki which may be different for different set point currents and battery string configurations. As the batteries age, and the internal resistance changes, there is also a concern that adjustments may be necessary to these constants, and it is undesirable for such changes to be necessary once the equipment has been installed or the battery serviced. Conservative choices for the constants result in a much longer time period for the adjustment of the rectifier voltage to reach the set point current thus increasing the time to fully recharge the battery.

Configutring the rectifier voltage control loop so that the increase in voltage is rapid at the beginning of a charging cycle, but transitions to a slower control law once the transition from discharging to charging is reached can achieve the more rapid recharging of the battery without exceeding the maximum string current. Choosing the particular form of the control law modification for each regime is not critical, but it may be easier to express the shaping functions as analytic functions. Alternatively a look-up table for each regime could be used.

In an example, function 600 can be inserted in the control loop so that two or more different shaping laws mayused, depending on whether the overall battery condition is discharging or charging.

The control CV is input to the control modification operation, and the appropriate control function is chosen, depending on whether the battery current (the PV) is greater or less than a predetermined limit. For example, the transition may be, for rxample, when the PV is −5 amperes. The CV may be modified by a square-root function (620) if the current is less than −5 amps or by an offset cube-root function 610 when the current is greater than −5 amps.

More generally, a first shaping function and a second shaping function may be use, and the selection of the first or the second shaping function is determined by the charging state of the battery. Additional shaping functions may be defined for use during the transition from the discharging state to the charging state.

This modification of the control loop has been found to be effective over a wide range of set-point currents and battery string configuration and may therefore be preset during the manufacturing process for the DC Power Plant. The set-point current may changed by the user without the risk of overstressing the batteries, while adhering to the the manufacturer's recommendations.

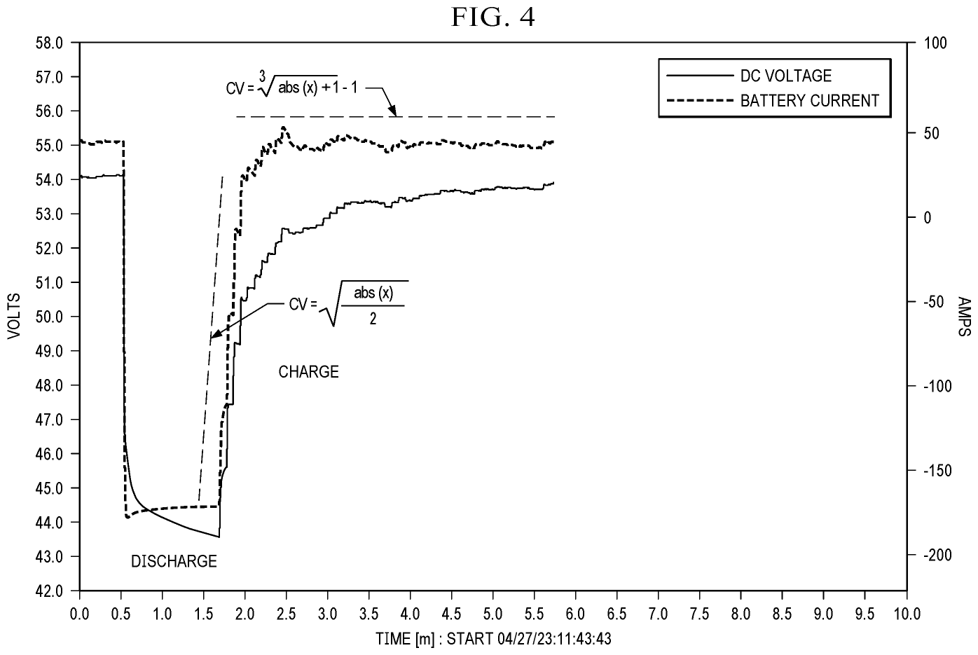

The result of a simulation using the same set-point current and the same gain values for kp and ki as in FIG. 2 is shown in FIG. 4. The rectifier voltage is raised rapidly, but the resultant current does not overshoot the set-point current and the process rapidly converges on the set-point current.

In a method of managing the charging of a battery, a string of batteries or a plurality of strings of batteries connected in parallel, a rectifier having a controllable voltage output, an ammeter connected in series with the battery and a controller with a memory for storing computer instructions, comprising:
measuring a value of a current input to a battery;
comparing the measured current value to a predetermined set-point current value to determine an error value;
using a proportional integral controller to produce a control voltage; modifying the control voltate according to a first control law or a second control law, depending on on the value of the measured current being greater than or less than a predetermined transition value; and
using the modified control voltage to change the controllable output voltage until the controllable voltage value is equal to a predetermined float voltage value.

In an aspect, the first control law and the second control law may be analytic functions such as a square-root function or a offset cube-function or a numerical approximation thereof. The first control law being a square root of the control voltage can permit the controolable voltage to rise rapidly after power is restored to the equipment so that the rectifiers begin to supply current to the load and reduce the need of current from the battery, but transitioning to a cube-root control law at about the time that the rectifier voltage is sufficient to supply the needs of the load and to begin to supply energy to the battery so that the battery charging current does not exceed the set-point current. In this way the re-charging process is expedited safely.

Since the process depends only on the sign and magnitude of the current measured at the input to the batteries, and this is determined by the number of battery strings and the specific battery manufacturer recommendations, the equipment using this method can be used for a large number of application cases without field adjustment of the control parameters. In the simulations shown, the transition current is −5 amps, which is not a critical parameter and may be positive or negative.

In another aspect, the limitation of the maximum voltage output of the rectifier to the float voltage avoids overcharging of the battery, since the float voltage is achieved when the battery is fully charged and the rectifier is supplying all of the current required by the load. When the battery is approaching a fully-charged state, the charging current at a fixed supply voltage will slowly decline from the set-point current to a very low predictable level where only the intrinsic energy losses of the battery are supplied. This portion of the charging cycle is not shown in the simulations.

One should note that this discussion has dealt with the recharging the batteries where there are no faults in the batteries. As is known, batteries occasionally fail or suffer thermal runaway. Such contingencies are usually addressed by other ancillary systems which may measure the time taken to reach a fully charged state, the actual current when the supply voltage is equal to the float voltage, battery temperature, or the like.

While the methods disclosed herein have been described and shown with reference to particular steps performed in a particular order, it will be understood that these steps may be combined, sub-divided, or reordered to from an equivalent method without departing from the teachings of the present invention. Accordingly, unless specifically indicated herein, the order and grouping of steps is not a limitation of the present invention.

In another aspect, a software product is stored in a computer-readable medium, and the instructions of the product configure a computer to perform the control functions of the DC Power Plant and the steps in a method of use.

It is therefore intended that the foregoing detailed description be regarded as illustrative rather than limiting, and that it be understood that it is the following claims, including all equivalents, that are intended to define the spirit and scope of this invention.

What is claimed is:

1. A DC Plant, comprising:
an AC-DC power converter having a controllable DC output voltage and DC output terminal;
a first connection from a to a storage battery;
an ammeter connected between a DC output the connection to the storage battery;
a second connection between the DC output terminal and an electrical load;
a controller configured to determine a value of a current flowing through the ammeter and to control a AC-DC power converter DC output terminal voltage such that an error signal, being a difference between a set-point current and a sampled current value, is processed by a proportional integral (PI) control module; and, an output control value of the PI controller is modified by a by a predetermined transfer function so that, when used to control a DC output terminal voltage, the current remains at or below a set-point current value.

2. The DC Power Plant of claim 1, wherein the predetermined transfer function is a square-root function of an output of the PI control module at a beginning of a charge cycle and a cube-root function when the current is greater than or equal to a predetermined current.

3. The DC Power Plant of claim 2, wherein the square-root function and the cube-root function are numerical approximations.

6. The DC Power Plant of claim 1, wherein a Low-Voltage Load Disconnect device (LVLD) is connected in a series circuit between the DC output terminal and the electrical load and is configured to open the series circuit when a storage battery terminal voltage is less than a predetermined value.

7. The DC Power Plant of claim 1 wherein the set-point current in amperes is a predetermined percentage of a storage battery ampere-hours (Ah) rating.

8. The DC Power Plant of claim 1, where the storage battery is one of a single storage battery, a plurality of storage batteries connected in a series string, or a plurality of strings of storage batteries connected in parallel.

9. A method of managing charging of a battery, a string of batteries or a plurality of strings of batteries connected in parallel, by a DC Power Plant having a rectifier with a controllable DC voltage output, an ammeter connected in a series path with the battery and a controller with a memory for storing computer instructions, comprising:
measuring a value of a current input to the battery;
comparing a current measured by the ammeter to a predetermined set-point current value to determine an error value;
using a proportional integral (PI) controller to produce a control voltage;
modifying the control voltage according to a first control law or a second control law, depending on on the value of the current measured by the ammeter being greater than or less than a predetermined transition current value; and
using the modified control voltage to increase the controllable voltage output of the rectifier until value is equal to a set-point current.

10. The method of claim 9, wherein the first control law is a square-root function or numerical approximation thereto

11. The method of claim 9, wherein the second control law is a offset cube-root function or a numerical approximation thereto.

12. The method of claim 9, wherein a predetermined float voltage value is used to limit a maximum DC output voltage.

13. The method of claim 9, wherein the set-point current is between 0.1 C and 0.4 C, where C is a specified capacity of the battery in ampere-hours.
